(19) United States
(12) Patent Application Publication
(10) Pub. No.: US 2011/0127216 A1
(43) Pub. Date: Jun. 2, 2011

(54) METHOD AND DEVICE FOR BIOLOGICAL TREATMENT OF WATER IN SWIMMING POOLS

(76) Inventor: Peter Petrich, Klosterneuburg (AT)

(21) Appl. No.: 12/937,123

(22) PCT Filed: Apr. 6, 2009
(86) PCT No.: PCT/EP2009/054069

§ 371 Date: Feb. 1, 2011

(30) Foreign Application Priority Data
Apr. 11, 2008 (AT) A 572/2008

(51) Int. Cl. C02F 9/14; C02F 1/42; E04H 4/16

(52) U.S. Cl. 210/631; 210/167.1; 210/167.19; 210/167.13

(57) ABSTRACT

The invention relates to a method for biological treatment of water in swimming pools. The method requires neither chlorine nor other toxic chemicals in the pool water, since near-surface pool water is mechanically purified in a first water circuit and suspended matter situated in the pool water is first retained in a biological filter (9) in a second water circuit and organic matter contained in said suspended matter, such as algae or detritus, and also organic matter dissolved in the pool water, are mineralized by the action of bacteria, wherein the phosphorus contained in the organic matter is catabolyzed to form dissolved reactive phosphate that is then bound by adsorption in an anion exchanger (14).

The invention relates to a method and a device for biological treatment of water in swimming pools.

In the conventional purification of water in swimming pools, the pool water is passed out via a bottom outlet and a skimmer or, if present, a surface channel, and mechanically purified in a filter, in particular a sand filter. In addition it is necessary to add disinfectant, for example chlorine, to the pool water, in order to prevent the multiplication of pathogens and algae.

In what are termed natural swimming ponds, the water treatment proceeds principally with the aid of water plants and/or biological filters. Natural swimming ponds are therefore enjoying increasing popularity. A certain disadvantage of natural swimming ponds is, however, that their area requirement is relatively high, since the planted treatment zone takes up a proportion of 25% to 75% of the water area. Furthermore, unsightly algal blooms can occur in natural swimming ponds. Some users of natural swimming ponds consider it to be a further disadvantage that in such a near-natural habitat, organisms such as water insects or amphibians rapidly colonize.

The object underlying the invention is to provide a method and a device for treating the pool water for swimming pools, which method requires neither chlorine nor other toxic chemicals in the pool water and does not have the disadvantages mentioned of natural swimming ponds.

As far as the method is concerned, the object in question is achieved according to the invention in that near-surface pool water is mechanically purified in a first water circuit and in that suspended matter situated in the pool water is first retained in a biological filter in a second water circuit and organic matter contained in said suspended matter, such as algae or detritus, and also organic matter dissolved in the pool water, are mineralized by the action of bacteria, wherein the phosphorus contained in the organic matter is catabolyzed to form dissolved reactive phosphate that is then bound by adsorption in an anion exchanger.

The system according to the invention is characterized in that a first pump-operated water circuit is provided for near-surface pool water having a mechanical filter appliance and a second, also pump-operated, water circuit is provided having a biological filter and an anion exchanger arranged downstream of the latter.

The invention therefore makes possible the operation of a swimming pool without the use of chlorine or other disinfectants. In the one water circuit, the mechanical purification of near-surface pool water proceeds, and in the second water circuit, in a biological filter, retention of suspended matter and mineralization of organic matter situated in the pool water proceed, wherein the phosphorus contained in the organic matter is catabolyzed to form dissolved phosphate that is then bound by adsorption in an anion exchanger. The growth of algae in the pool water is thereby largely prevented by phosphorus limitation, by analogy with natural lakes.

The mechanical purification of the near-surface pool water and the implementation of the associated water circuit are possible in a variety of ways. A particularly simple and at the same time very effective measure is to filter the near-surface pool water through a sieve, in particular a bow screen sieve. Sieves reliably retain impurities and may be easily cleaned.

Each water circuit is operated by a separate pump which, with respect to its power, is geared to the requirements of the respective water circuit. A particular advantage of the combination of biological filter and anion exchanger in the second water circuit is that both filters require only a relatively low through-flow, and so a single pump is sufficient for operating this circuit and intermediate storage of pool water is not required.

In one embodiment of the invention, the biological filter is a fine-grained filter material, in particular sand or porous material, having bacteria colonized thereon. The biological filter may thereby be constructed in an expedient and inexpensive manner, and any cleaning that is necessary or replacements are possible without problems.

In a further preferred embodiment of the invention, the anion exchanger is accommodated in a container that is let into the ground. The anion exchanger can therefore be positioned in a readily accessible and at the same time visually inconspicuous manner for maintenance work. Connection tubes that are required in the circuits are preferably laid below ground.

The biological filter can likewise be arranged inconspicuously and in particular close to the swimming pool. It is expedient, for example, to arrange the biological filter below a wooden bridge or the like or below ground with a detachable covering.

The pumps present in both water circuits can be accommodated in an expedient and simple manner in a joint pump shaft that is let into the ground.

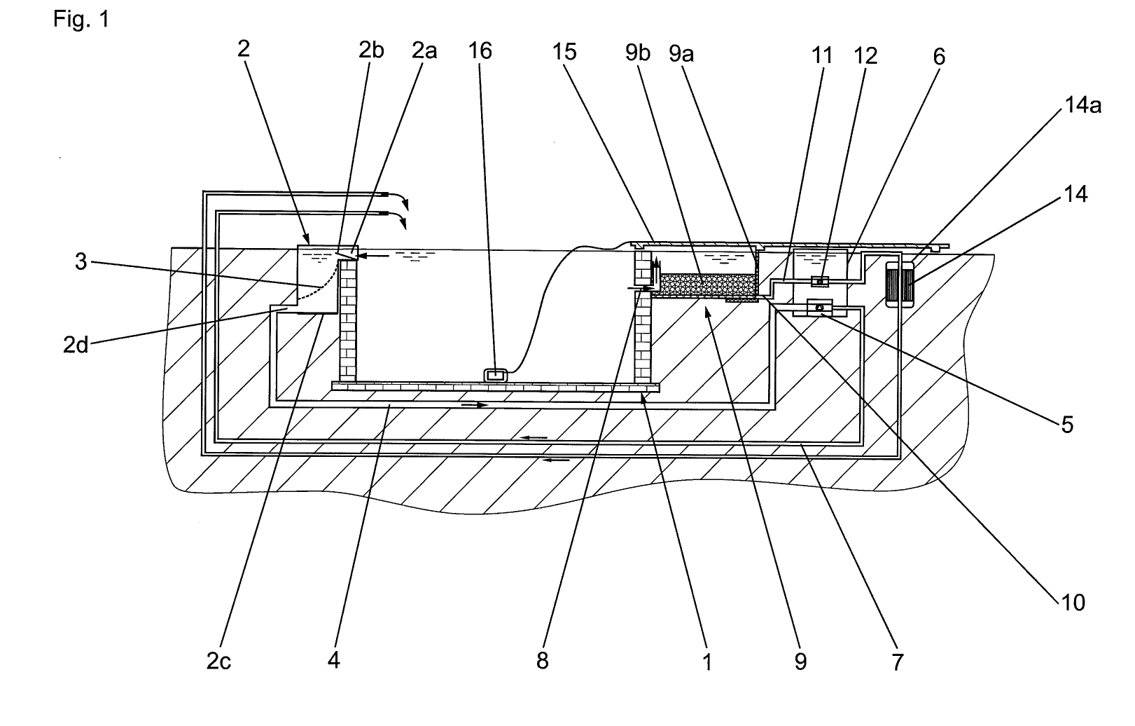

Further features, advantages and details of the invention will now be described in more detail with reference to the drawing. The single FIGURE, FIG. 1, shows schematically one variant embodiment of a device according to the invention.

FIG. 1 shows a swimming pool 1, which can be constructed in a conventional manner, for example as a concrete pool having a film cladding. For purifying the water in the swimming pool 1, two separate water circuits are provided that are operated simultaneously.

The one water circuit serves for mechanical purification or filtration of the near-surface swimming pool water. This circuit, in the embodiment of the invention shown, comprises a skimmer 2 that is connected to the swimming pool 1 close to the water surface, which skimmer, in the embodiment shown, has a feed 2a having a freely pivotable skimmer flap 2b, a skimmer housing 2c, and also an outlet 2d in the bottom region thereof. In the housing 2c, a sieve, for example a bow screen sieve 3, is accommodated for filtering the swimming pool water. A pipe 4 laid in the ground connects the outlet 2d of the skimmer 2 to a pump 5 which is accommodated in a separate pump shaft 6 that is let into the ground. Via a further pipe 7 that is laid in the ground, the water is pumped back into the swimming pool 1. In this water circuit, water is therefore taken off from the water surface by suction and mechanically purified from particles, suspended materials and the like in a filter or sieve 3. Purified water can be fed to the pool interior via inflow nozzles, in a manner that is not shown. If a surface channel is laid around the swimming pool 1, the water can be drawn from this channel by suction into a container/shaft in which there is a sieve/filter. For this water circuit, the use of a relatively powerful pump 5 is advantageous. In order to save electrical energy, the pump 5 is preferably only operated for a few hours per day.

In the second water circuit, in the swimming pool water, in a similar manner to natural lakes, the growth of algae is limited or substantially prevented by phosphorus limitation. For this purpose, the pool water is treated in the second water circuit in two steps. The pool water passes through an outlet 8 provided in the pool wall, preferably directly, into a biological filter 9. The biological filter 9 consists of a flat container 9a that is let into the ground and which is packed up to a certain height with a fine-grained, inert filter material 9b, preferably sand or porous materials such as expanded clay or lava rock. The pool water that is drawn in by suction via a second pump 12 that is positioned in the pump shaft 6 percolates through the filter material 9b, wherein suspended matter (these are the particulate impurities), such as algae, detritus and suspended materials, are filtered out. The filter 9 therefore acts as a mechanical filter by retaining the suspended matter. The biological filter action of the filter material 9b is based on the activity of bacteria. The bacteria develop spontaneously, form a biological lawn on the grain surfaces of the filter material and adapt, with some time delay, to the water loading that occurs.

The suspended matter in the pool water originates from introductions from the environment such as leaves, dust, insects, and from impurities introduced by use, for example skin residues, and also from the organic substances formed such as algae. The pool water in addition contains dissolved organic matter as impurities. The suspended matter, as mentioned, is retained in the filter 9, organic matter—dissolved and particulate—is mineralized by the bacteria which has colonized in the filter material. The phosphorus that is contained in this organic matter is catabolyzed to form dissolved phosphate, substantially orthophosphate (PO₄³⁻). The filtered percolated pool water leaves the biological filter 9 at the bottom of the container 9a via an outlet 10 to which a pipe 11 is connected that leads to the pump 12. The pump 12 pumps the pool water that is filtered in the biological filter 9 to a container 14a that is likewise let into the ground and which contains an anion exchanger 14. The anion exchanger 14 binds, by adsorption, the negative ions from the pool water, in particular and preferably PO₄³⁻, but also nitrite (NO₂⁻) and nitrate (NO₂⁻). The phosphorus concentration in the pool water is reduced in this method to a very low value, in particular to less than 10 μg/l, as a result of which primary production of algae or algal growth is substantially prevented in the pool water. The pump 12 conveying pool water through the anion exchanger 14 has only a relatively low power and runs permanently. A circulation time for all of the pool water of the order of magnitude of two days has proved to be sufficient. Therefore, the volume and the area of the biological filter 9 can also be kept relatively small, and so the filter container 9a can readily be accommodated, for example, below a wooden bridge 15. The biological filter 9 is in addition provided with a light-impermeable cover, and so no unwanted algae can colonize it. An arrangement of the biological filter 9 below ground is also possible.

Since the pool water is well purified from suspended matter in the biological filter 9, the downstream anion exchanger 14 only needs to be backwashed rarely. The anion exchanger 14 is replaced after a certain operating time, as soon as it is saturated with phosphate.

A particular advantage of the combination of biological filter 9 and anion exchanger 14 is that both filters require only a relatively low through-flow, the biological filter 9 in order that the biological methods proceed optimally and the biological lawn is not floated off, and the anion exchanger 14, because a certain contact time is necessary for the adsorption. Therefore, both components 9, 14 can be charged with the same hydraulic through-flow.

For cleaning the pool bottom and the pool walls, a conventional pool robot can be used which is operated at relatively short intervals, for example daily. By using a robot, the growth of filamentous algae on the pool walls can be effectively prevented.

By taking samples, in particular of water in the pool, from the outlet of the anion exchanger and immediately downstream of the biological filter, the phosphorus concentration, the pH, the oxygen concentration and other parameters can be continuously monitored.

The invention is not restricted to the embodiment(s) shown and described. Other skimmer types than that described can be used. The biological filter can also be constructed as a trickling filter or microfiber filter.

### LIST OF REFERENCE NUMBERS

1 . . . Swimming pool
2 . . . Skimmer
2a . . . Feed
2b . . . Skimmer flap
2c . . . Housing
2d . . . Outlet
3 . . . Sieve
4 . . . Pipe
5 . . . Pump
6 . . . Pump shaft
7 . . . Pipe
8 . . . Outlet
9 . . . Biological filter
9a . . . Container
9b . . . Filter material
10 . . . Outlet
11 . . . Pipe
12 . . . Filter pump
14 . . . Anion filter
14a . . . Container
15 . . . Wooden bridge

1. Method for biological treatment of water in swimming pools, characterized in that near-surface pool water is mechanically purified in a first water circuit and in that suspended matter situated in the pool water is first retained in a biological filter in a second water circuit and organic matter contained in said suspended matter, such as algae or detritus, and also organic matter dissolved in the pool water, are mineralized by the action of bacteria, wherein the phosphorus contained in the organic matter is broken down to form dissolved reactive phosphate that is then bound by adsorption in an anion exchanger.

2. Method according to claim 1, characterized in that the near-surface pool water is filtered through a sieve, in particular a bow screen sieve.

3. Method according to claim 1, characterized in that each water circuit is operated by a pump.

4. Device for biological treatment of water in swimming pools, characterized in that a first pump-operated water circuit is provided for near-surface pool water having a mechanical filter appliance and a second, also pump-operated, water circuit is provided having a mechanical/biological filter and an anion exchanger arranged downstream of the latter.

5. Device according to claim 4, characterized in that the mechanical filter appliance in the first water circuit has a sieve, in particular a bow screen sieve.

6. Device according to claim 4, characterized in that the biological filter comprises a fine-grained filter material, in particular sand or porous material, having bacteria colonized thereon.

7. Device according to claim 4, characterized in that the anion exchanger is accommodated in a container that is let into the ground.

8. Device according to claim 4, characterized in that the biological filter is covered by a wooden bridge or is arranged below ground.

9. Device according to claim 4, characterized in that the pumps present in both water circuits are accommodated in a joint pump shaft that is let into the ground.
